(19) United States
(12) Patent Application Publication
(10) Pub. No.: US 2025/0267659 A1
(43) Pub. Date: Aug. 21, 2025

(54) PROCEDURE FOR NON-TERRESTRIAL NETWORK COVERAGE ENHANCEMENT WITH ULTRA COMPACT DOWNLINK CONTROL INFORMATION AND SCHEDULING PHYSICAL DOWNLINK SHARED CHANNEL

(71) Applicant: APPLE INC., Cupertino, CA (US)

(72) Inventors: Chunxuan Ye, San Diego, CA (US); Dawei Zhang, Saratoga, CA (US); Hong He, San Jose, CA (US); Wei Zeng, San Diego, CA (US); Weidong Yang, San Diego, CA (US); Chunhai Yao, Beijing (CN); Seyed Ali Akbar Fakoorian, San Diego, CA (US); Yushu Zhang, Beijing (CN); Dan Zhang, San Diego, CA (US); Ruoheng Liu, San Diego, CA (US)

(21) Appl. No.: 18/859,205

(22) PCT Filed: Apr. 27, 2023
(86) PCT No.: PCT/US2023/066298

§ 371 Date: Oct. 23, 2024

Related U.S. Application Data
(60) Provisional application No. 63/363,720, filed on Apr. 28, 2022.

(51) Int. Cl. H04W 72/1273; H04L 1/1812

(52) U.S. Cl. CPC H04W 72/1273; H04L 1/1812

(57) ABSTRACT

System and methods for using ultra compact downlink control information (DCI) in conjunction with one or more scheduling physical downlink shared channels (PDSCHs) are disclosed herein. A base station may transmit, to a user equipment (UE), an ultra compact DCI that schedules the one or more scheduling PDSCHs. The one or more scheduling PDSCHs may schedule a data PDSCH or physical uplink shared channel (PUSCH) that is to be used for user/application layer data transmission. The ultra compact DCI and/or the one or more scheduling PDSCHs may be as configured by a system information block (SIB). The ultra compact DCI and/or the one or more scheduling PDSCHs may schedule a physical uplink control channel (PUCCH) used for hybrid automatic repeat request acknowledgement (HARQ-ACK) signaling relative to the one or more scheduling PDSCHs. Aspects regarding the use of these systems and methods in non-terrestrial network (NTN) contexts are considered.

### TECHNICAL FIELD

This application relates generally to wireless communication systems, including wireless communication systems using ultra compact DCI and/or one or more scheduling physical downlink shared channel (PDSCH) for scheduling PDSCHs and/or physical uplink shared channel (PUSCHs) for data transmission (e.g., user/application data transmission).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an NTN architecture of a wireless communication system, according to an embodiment.

FIG. 2 illustrates an NTN architecture of a wireless communication system, according to an embodiment.

FIG. 3 illustrates a diagram for a dynamic resource grant procedure for DL data transmission, according to an embodiment.

FIG. 4 illustrates a diagram for a dynamic resource grant procedure for UL data transmission, according to an embodiment.

FIG. 5 illustrates a diagram for a dynamic resource grant procedure for DL data transmission using ultra compact DCI and one or more scheduling PDSCHs, according to an embodiment.

FIG. 6 illustrates a diagram for a dynamic resource grant procedure for DL data transmission using ultra compact DCI and one or more scheduling PDSCHs, according to an embodiment.

FIG. 7 illustrates a method of a base station, according to an embodiment.

FIG. 8 illustrates a method of a UE, according to an embodiment.

FIG. 9 illustrates a diagram for a dynamic resource grant procedure for UL data transmission using ultra compact DCI and one or more scheduling PDSCHs, according to an embodiment.

FIG. 10 illustrates a diagram for a dynamic resource grant procedure for UL data transmission using ultra compact DCI and one or more scheduling PDSCHs, according to an embodiment.

FIG. 11 illustrates a method of a base station, according to an embodiment.

FIG. 12 illustrates a method of a UE, according to an embodiment.

FIG. 13 illustrates an example architecture of a wireless communication system, according to embodiments disclosed herein.

FIG. 14 illustrates a system for performing signaling between a wireless device and a RAN device connected to a core network of a CN device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

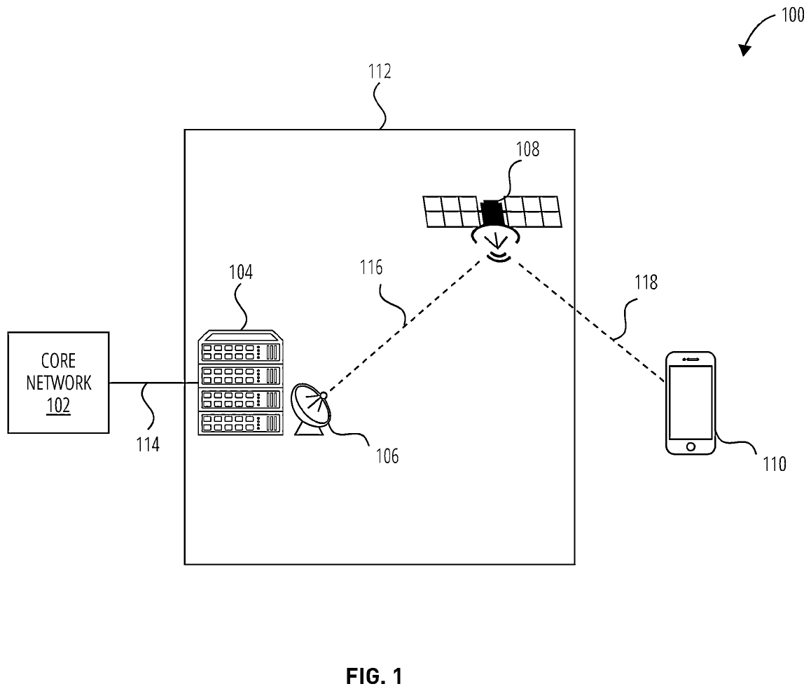

FIG. 1 illustrates a non-terrestrial network (NTN) architecture 100 of a wireless communication system, according to an embodiment. The NTN architecture 100 includes a core network (CN) 102, a terrestrial base station 104, a satellite gateway 106, a satellite 108, and a UE 110. The terrestrial base station 104, the satellite gateway 106, and the satellite 108 may be included in a RAN 112.

In some embodiments, the RAN 112 includes E-UTRAN, the CN 102 includes an EPC, and the terrestrial base station 104 includes an eNB. In these cases, the CN link 114 connecting the CN 102 and the terrestrial base station 104 may include an S1 interface.

In some embodiments, RAN 112 includes NG-RAN, the CN 102 includes a 5GC, and the terrestrial base station 104 includes a gNB or a next generation eNB (ng-eNB). In such cases, the CN link 114 connecting the CN 102 and the terrestrial base station 104 may include an NG interface.

The NTN architecture 100 illustrates a “bent-pipe” or “transparent” satellite based architecture. In such bent-pipe systems, the terrestrial base station 104 uses the satellite gateway 106 to communicate with the satellite 108 over a feeder link 116. The satellite 108 may be equipped with one or more antennas capable of broadcasting a cell according to the RAN 112, and the UE 110 may be equipped with one or more antennas (e.g., a moving parabolic antenna, an omni-directional phased-array antenna, etc.) capable of communicating with the satellite 108 via a Uu interface on that cell (such communications may be said to use the illustrated service link 118). A payload sited on the satellite 108 then transparently forwards data between the satellite gateway 106 and the UE 110 using the feeder link 116 between the satellite gateway 106 and the satellite 108 and the service link 118 between the satellite 108 and the UE 110. The payload may perform RF conversion and/or amplification in both uplink (UL) and downlink (DL) to enable this communication.

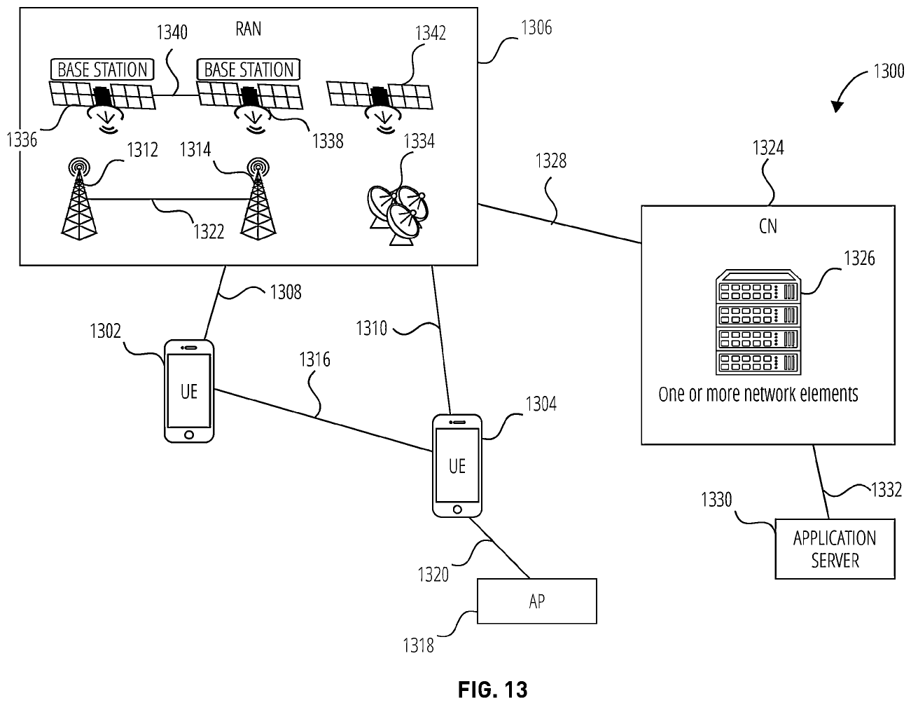

In the embodiment shown in FIG. 1, the terrestrial base station 104 is illustrated without the capability of terrestrial wireless communication directly with a UE. However, it is contemplated that in other embodiments, such a terrestrial base station using the satellite gateway 106 to communicate with the satellite 108 could (also) have this functionality (i.e., as in the terrestrial base station 1312 and the terrestrial base station 1314 of FIG. 13, to be described below).

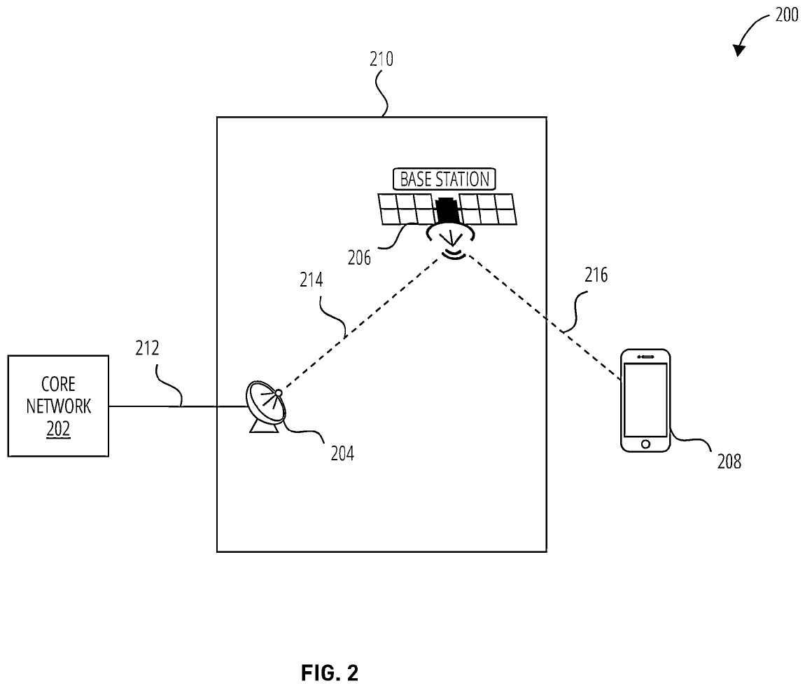

FIG. 2 illustrates an NTN architecture 200 of a wireless communication system, according to an embodiment. The NTN architecture 200 includes a CN 202, a satellite gateway 204, a satellite base station 206, and a UE 208. The satellite gateway 204 and the satellite base station 206 may be included in the RAN 210.

In some embodiments, the RAN 210 includes E-UTRAN and the CN 202 includes an EPC. In these cases, the CN link 212 connecting the CN 202 and the satellite gateway 204 may include an S1 interface.

In some embodiments, RAN 210 includes NG-RAN and the CN 202 includes a 5GC. In such cases, the CN link 212 connecting the CN 202 and the satellite gateway 204 may include an NG interface.

The NTN architecture 200 implements a “regenerative” satellite based architecture. In such regenerative systems, the functionalities of a base station are sited on the satellite base station 206, and the communications between these base station functions and the CN 202 occur through a forwarding of interface(s) (e.g., a S1 interface and/or an NG interface) found on the CN link 212 through the satellite gateway 204 and a feeder link 214 to the satellite base station 206. The satellite base station 206 may be equipped with one or more antennas capable of broadcasting a cell according to the RAN 210, and the UE 208 may be equipped with one or more antennas (e.g., a moving parabolic antenna, an omni-directional phased-array antenna, etc.) capable of communicating with the satellite base station 206 via a Uu interface on that cell (such communications may be said to use the illustrated service link 216). A payload sited on the satellite base station 206 then forwards data between the satellite gateway 204 and the UE 208 using the feeder link 214 between the satellite gateway 204 and the satellite base station 206 and the service link 216 between the satellite base station 206 and the UE 208. The payload may perform RF conversion and/or amplification in both uplink (UL) and downlink (DL) to enable this communication, as well as implement the functionalities of the base station (e.g., as an eNB, ng-eNB or a gNB, as corresponding to the type of the RAN 210), as these have been sited on the satellite base station 206.

In embodiments of NTN architectures comprising NG-RAN that also use integrated access and backhaul (IAB), it is possible that a gNB control unit functionality (CU) could be sited terrestrially and may use a satellite gateway to communicate with a satellite that hosts a corresponding gNB donor unit functionality (DU), with the F1 interface(s) between the CU and the DU underpinned by the feeder link 214. In such cases, the CU and the DU may each be understood to be part of the NG-RAN.

Characteristic differences of NTNs versus terrestrial networks may include relatively larger propagation delays and the potential for movement of the satellite relative to a current position of a UE. Accordingly, improvements to wireless communications systems may be intended to help to alleviate undesirable effects stemming from these circumstances. Such improvements may respond to the need to improve various services provided to a UE by an NTN (e.g., voice service, data service), in view of real-world characteristics of NTN performance (e.g., as opposed to an idealized case). Such improvements to NTN use may be arranged to account for relevant regulatory restrictions, such as limitations on power flux density (PFD) at surface/ground level as established by the International Telecommunications Union (ITU). It will be understood that in some circumstances, such improvements may be achieved (at least in part) via a particular use of one or more physical radio channels in a way that helps to alleviate these and other NTN-related issues.

In some instances, pairing of the L-band (e.g., 1,610 megahertz (MHz) to 1,618.775 MHz) and the S-band (e.g., 2,483.5 MHz to 2,500 MHz) may be considered. For example, it may be that the L-band may be used for UL between a satellite and a UE while the S-band may be used for DL between the satellite and the UE.

A PFD limitation on the use of this S-band may be applicable according to various regulations. For example, as applicable in a mobile-satellite service context in in the 2,483.5 MHz to 2,500 MHz range, a PFD limitation may be expressed in terms of the PFD calculation factors P (expressed in dB (W/m²) per MHz or per X kilohertz (kHz)) and r (expressed in dB/degree). Values for these PFD calculation factors may depend on whether a satellite is a GSO satellite or a non-GSO satellite. The appropriate values for the PFD calculation factors may be applied in a defined way relative to an angle of arrival above the horizontal plane (relative to a location on the earth's surface) δ (in degrees) to arrive at the PFD limitation.

For example, a satellite in a geostationary orbit (GSO) may correspond to PFD calculation factors P=−146 dB (W/m²) in 4 kHz or −128 dB (W/m²) in 1 MHz and r=0.5 dB/degree, while a satellite in a non-GSO may correspond to parameters P=−144 dB (W/m²) in 4 kHz or −126 dB (W/m²) in 1 MHz and r=0.65 dB/degree. In some regions, a satellite in a non-GSO may instead use P=−142.5 dB (W/m²) in 4 kHz and −124.5 dB (W/m²) in 1 MHz.

Then, using the appropriate PFD calculation factors P and r according to the applicable satellite information, a PFD limitation relative to the satellite can be calculated according to the applicable & between a UE location and the satellite using:

$$PFD = P , for 0 ° \leq δ \leq 5 ° ; \\ PFD = P + r ( δ - 5 ) , for 5 ° \leq δ \leq 25 ° ; and \\ PFD = P + 20 r , for 25 ° \leq δ \leq 90 ° .$$

Within such PFD constraints as calculated, it may be that DL transmission power (or effective isotropic radiated power (EIRP)) in the 2,483.5 MHz to 2,500 MHz range cannot be large enough to cover the entire geographic cell of the satellite with strong coverage.

Accordingly, the use of embodiments described herein may, for example, enhance the DL coverage experienced by a UE within the cell of the satellite when such circumstances as described here are applicable.

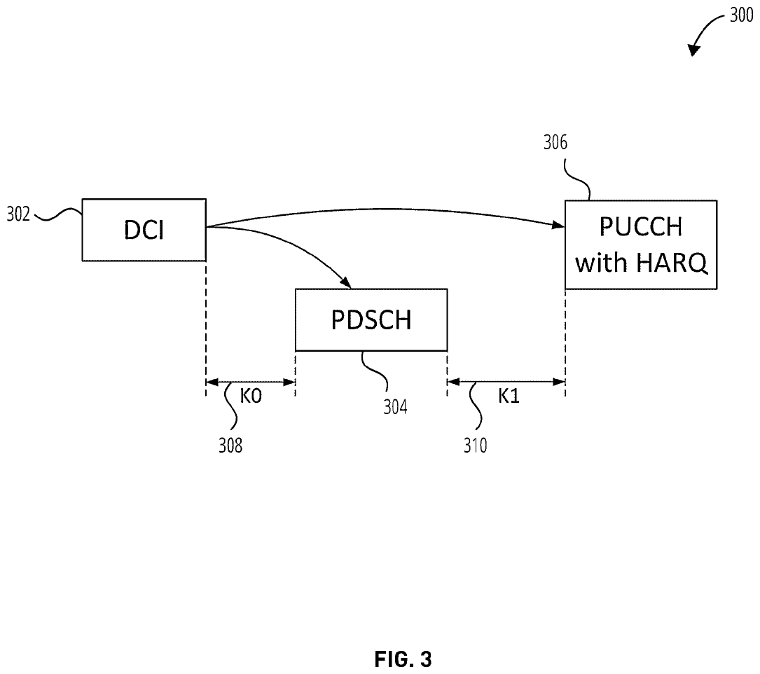

FIG. 3 illustrates a diagram 300 for a dynamic resource grant procedure for DL data transmission, according to an embodiment. The diagram 300 illustrates that the downlink control information (DCI) 302 is sent from a base station to a UE. The DCI 302 may be carried in a physical downlink control channel (PDCCH). The DCI 302 may be, for example, of DCI format 1_0, 1_1, or 1_2.

The DCI 302 may indicate to the UE that the network has allocated the PDSCH 304 with DL data resources for the UE (e.g., the network has scheduled the use of the PDSCH 304 for the UE), and may further indicate to the UE the time and frequency location of the PDSCH 304. As illustrated, a minimum offset K0 308 between the DCI 302 scheduling the PDSCH 304 and the PDSCH 304 itself may be maintained by the network.

The DCI 302 may also indicate to the UE that the network has allocated the PUCCH 306 to be used by the UE for any hybrid automatic repeat request acknowledgement (HARQ-ACK) signaling related to the receipt and attempted decoding of the PDSCH 304 by the UE (e.g., the network has scheduled the use of the PUCCH 306 by the UE). As illustrated, a minimum offset K1 310 between the PDSCH 304 and the PUCCH 306 may be maintained by the network.

The UE may accordingly attempt to receive and decode the PDSCH 304 at the time/frequency resources that were indicated for the PDSCH 304 in the DCI 302. The UE may then transmit HARQ-ACK signaling corresponding to the result on the PUCCH 306. For example, if the receipt and decoding of the PDSCH 304 by the UE was successful, the HARQ-ACK signaling on the PUCCH 306 may comprise an acknowledgment (ACK). If the receipt and/or decoding of the PDSCH 304 was unsuccessful, the HARQ-ACK signaling on the PUCCH 306 may instead comprise a negative acknowledgement (NACK).

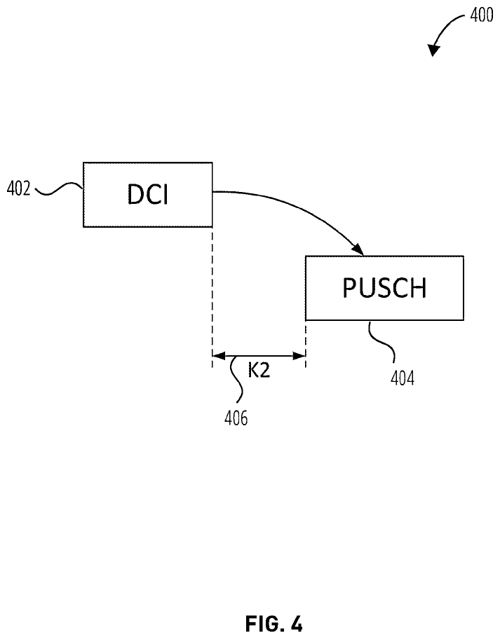

FIG. 4 illustrates a diagram 400 for a dynamic resource grant procedure for UL data transmission, according to an embodiment. The diagram 400 illustrates that the DCI 402 is sent from a base station to a UE. The DCI 402 may be carried in a PDCCH. The DCI 402 may be, for example, of DCI format 0_0, 0_1, or 0_2.

The DCI 402 may indicate to the UE that the network has allocated the PUSCH 404 for use by the UE for transmitting UL data (e.g., the network has scheduled the use of the PUSCH 404 for the UE), and may further indicate to the UE the time and frequency location of the PUSCH 404. As illustrated, a minimum offset K2 406 between the DCI 402 scheduling the PUSCH 404 and the PUSCH 404 itself may be maintained by the network.

The UE may accordingly transmit data on the PUSCH 404 at the time/frequency resources that were indicated for the PUSCH 404 in the DCI 402.

The procedures of FIG. 3 and FIG. 4 may be successfully used in certain cases (e.g., cases involving fully terrestrial networks) where aspects of the behavior of and/or relationship between a base station and a UE are as may be implicitly assumed in those scenarios. However, it has been recognized that in various circumstances, modifications to the procedures illustrated in (and described in relation to) FIG. 3 and FIG. 4 may be beneficial.

For example, in order to address NTN-related issues of additional signaling propagation time and/or distance, and/or of PFD limitations, it has been determined that PDSCH coverage as provided by a satellite of an NTN may be improved by using (a relatively large number of) PDSCH repetitions.

Further, it has been recognized that in the NTN context, PDCCH transmissions (e.g., for DCI, as described herein) may represent a bottleneck in various circumstances. For example, in the case where repeated PDCCHs are not configured for use in an NTN network, a (accordingly single) PDCCH may be more likely to be missed in the NTN context than in another context (e.g., than in a fully terrestrial context). Further, the use of PDCCH repetitions in an NTN context (in an attempt to reduce the chance that PDCCH signaling is altogether missed) may have an outsized negative impact on network throughput overall in some cases (e.g., due to the relatively increased signaling propagation time for the PDCCHs in the NTN context).

Accordingly, it has been recognized that by simplifying DCI use, the impact(s) felt from these PDCCH-related aspects may be reduced. DCI that are structured and/or used according to such a simplified use may be referred to herein as “ultra compact DCI.”

In some embodiments, this simplification may occur via the use of a DCI format for the ultra compact DCI that results in an overall reduced payload size for the ultra compact DCI as compared to payload sizes for DCI according to other DCI formats under the same parameters/circumstances. This may be accomplished in some embodiments by omitting one or more fields from the ultra compact DCI that would otherwise be present in the DCI of the other DCI formats. In some wireless communications networks, such as those that implement LTE RAT and/or NR RAT, it may be that such ultra compact DCI may accordingly have a reduced payload size as compared to a “compact DCI” (e.g., DCI of format 1_2 and/or 0_2) that are known to those networks.

In some embodiments, such a simplification may (alternatively or additionally) occur through the use of fixed values for one or more fields within the ultra compact DCI (which may aid in speeding and/or simplifying the decoding of the ultra compact DCI at the UE). In some of these embodiments, it may be that a payload size of an ultra compact DCI is accordingly not necessarily smaller than a payload size of a DCI of another DCI format known/used in the relevant wireless communication system.

It is noted that in some embodiments, a DCI format for an ultra compact DCI may define for fields beyond those provided for in other DCI formats known to/defined for the wireless communication system. Accordingly, in a subset of such embodiments, it is possible that an ultra compact DCI has a larger payload size than a payload size of a DCI of another DCI format known/used in the relevant wireless communication system (due to these additional fields).

Further, embodiments herein may provide at least some scheduling information for a PDSCH or PUSCH used for data transmission in one or more intervening PDSCHs that occur between the ultra compact DCI and the PDSCH/PUSCH for data transmission (rather than siting this information within the ultra compact DCI). These one or more intervening PDSCHs may be referred to herein as “scheduling PDSCHs.” By using one or more such scheduling PDSCHs to transport scheduling information for the PDSCH/PUSCH for data transmission between the base station and the UE, the payload size of the ultra compact DCI may be accordingly reduced. Herein, a PDSCH for data transmission may be referred to as a “data PDSCH” in order to differentiate it from any scheduling PDSCHs under discussion.

As will be described, in some embodiments, an ultra compact DCI and/or scheduling PDSCHs may further include scheduling information for a PUCCH that may be used by the UE to provide HARQ-ACK signaling to the base station relative to the scheduling PDSCHs. In some embodiments, this PUCCH occurs between the scheduling PDSCHs and the data PDSCH/the PUSCH that is used for data transmission. In some embodiments, this PUCCH may occur after the scheduling PDSCHs and the data PDSCH/the PUSCH that is used for data transmission.

Finally, it may be that the one or more scheduling PDSCHs comprise PDSCH repetitions (and this may be so even in cases where, for example, PDCCH repetition for the ultra compact DCI is not available and/or is not used), thereby increasing the chance of successful reception and decoding at the UE of the attendant scheduling information for the data PDSCH/PUSCH/PUCCH for HARQ (as the case may be).

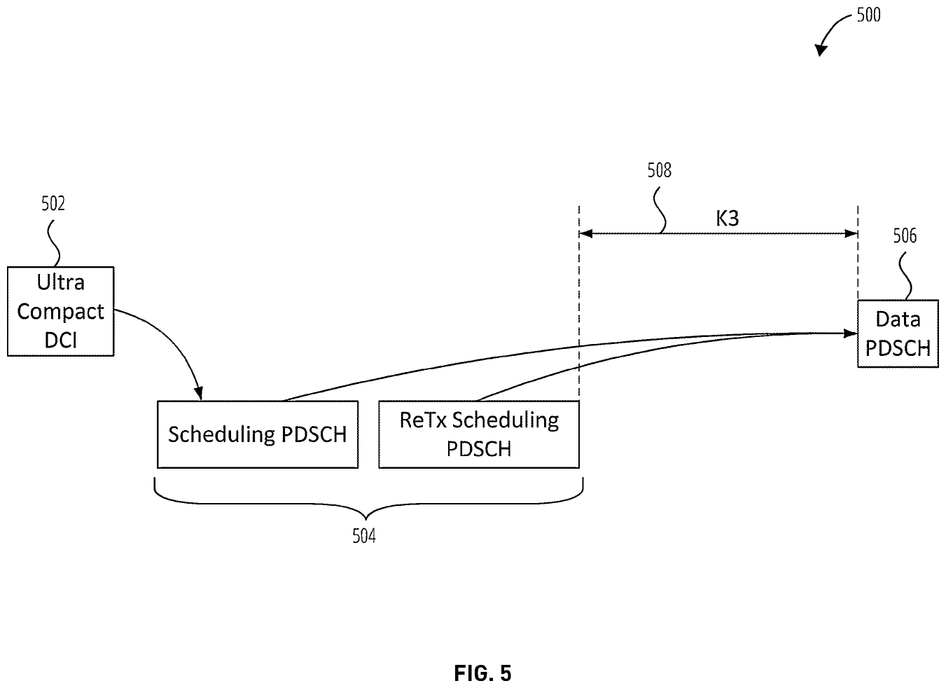

FIG. 5 illustrates a diagram 500 for a dynamic resource grant procedure for DL data transmission using ultra compact DCI and one or more scheduling PDSCHs, according to an embodiment. More specifically, the diagram 500 illustrates the use of an ultra compact DCI 502 and one or more scheduling PDSCHs 504 to schedule a data PDSCH 506 for the DL data transmission.

The diagram 500 illustrates that the ultra compact DCI 502 is transmitted by the base station and received at the UE. The ultra compact DCI 502 provides the UE with sufficient information such that the UE is made aware of the time and frequency location(s) of the one or more scheduling PDSCHs 504 (e.g., the ultra compact DCI 502 schedules the one or more scheduling PDSCHs 504).

The one or more scheduling PDSCHs 504 are then transmitted by the base station as scheduled and received at the UE. The one or more scheduling PDSCHs 504 may include one or more medium access control control elements (MAC CEs) that include scheduling information for the data PDSCH 506. The one or more scheduling PDSCHs 504 accordingly provide the UE (e.g., in the MAC CE(s)) with sufficient information such that the UE is made aware of the time and frequency location of the data PDSCH 506 (e.g., the one or more scheduling PDSCHs 504 schedule the data PDSCH 506).

In some embodiments, the one or more scheduling PDSCHs 504 comprises PDSCH repetitions. For example, in the case that the one or more scheduling PDSCHs 504 includes at least two PDSCHs, each of these two PDSCHs may be the same. In such cases, each of the one or more scheduling PDSCHs 504 would have, for example, a same MAC CE having scheduling information for the data PDSCH 506. The use of such repetitions may provide the UE with additional reception opportunities for this data, thereby improving the probability that the UE will successfully receive and/or decode this data.

The data PDSCH 506 is then transmitted by the base station as scheduled and is received at the UE. The data PDSCH 506 may include, for example, user plane (UP) data (e.g., application layer data for an application operating on the UE).

As illustrated, a minimum offset K3 508 between the last of the one or more scheduling PDSCHs 504 and the data PDSCH 506 may be maintained by the network. In other words, the ultra compact DCI 502 may schedule the one or more scheduling PDSCHs 504, and the one or more scheduling PDSCHs 504 may schedule the data PDSCH 506, such that a minimum offset K3 508 is maintained.

The base station may transmit a system information block (SIB) that includes configuration information for the ultra compact DCI 502 and/or for the one or more scheduling PDSCHs 504. The configuration information for the ultra compact DCI 502 as found in the SIB may be used by the UE to locate the ultra compact DCI 502.

Further, the configuration information for the one or more scheduling PDSCHs 504 as found in the SIB may further be used to locate the one or more scheduling PDSCHs 504 (in other words, the ultra compact DCI 502 may schedule the one or more scheduling PDSCHs 504 in light of/with the background assumption of any configuration for the one or more scheduling PDSCHs 504 provided in the SIB). In some cases, the configuration information for the one or more scheduling PDSCHs 504 in the SIB may relate the time and/or frequency position(s) of any of the one or more scheduling PDSCHs 504 relative to a received ultra compact DCI 502.

This SIB may be transmitted to the UE of the dynamic resource grant procedure of FIG. 5 by the base station of the dynamic resource grant procedure of FIG. 5 (e.g., that transmits the ultra compact DCI 502). Alternatively, the SIB may be transmitted to the UE of FIG. 5 by another base station.

In some cases, after receiving the data PDSCH 506, the UE may reply to the base station with HARQ-ACK signaling on a PUCCH (not illustrated in FIG. 5). For example, if the receipt and decoding of the data PDSCH 506 by the UE was successful, the HARQ-ACK signaling may comprise an ACK. If the receipt and/or decoding of the data PDSCH 506 was unsuccessful, the HARQ-ACK signaling may instead comprise a NACK.

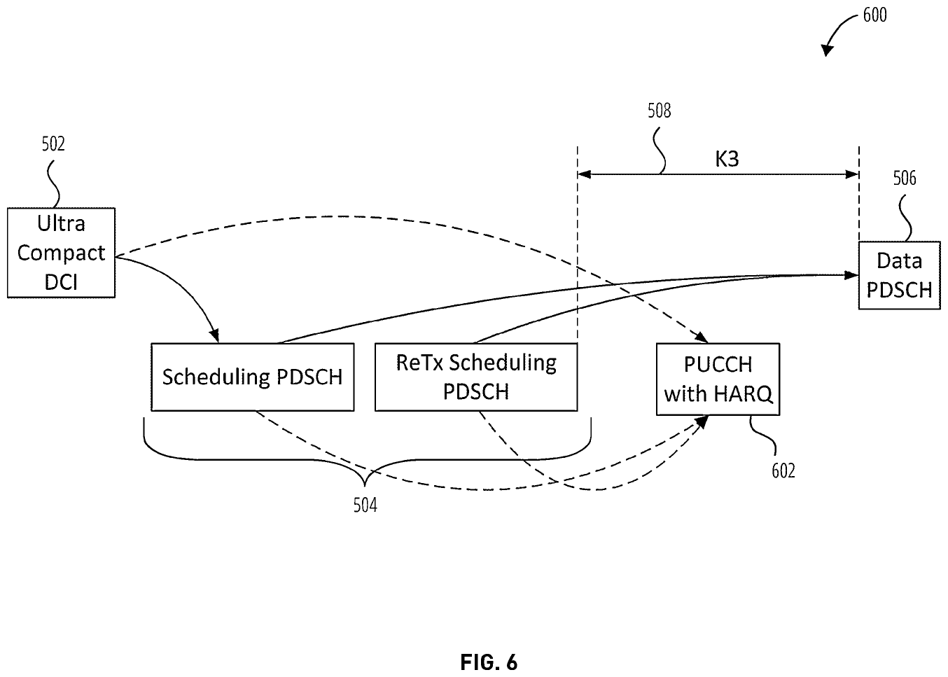

FIG. 6 illustrates a diagram 600 for a dynamic resource grant procedure for DL data transmission using ultra compact DCI and one or more scheduling PDSCHs, according to an embodiment. The diagram 600 is an expansion of the diagram 500 as described in relation to FIG. 5. Accordingly, the diagram 600 illustrates the use of the ultra compact DCI 502, the one or more scheduling PDSCHs 504, the data PDSCH 506, and the offset K3 508 as these were described in relation to the diagram 500 of FIG. 5. In addition to these elements from the diagram 500 of FIG. 5, the diagram 600 of FIG. 6 additionally illustrates the scheduling and use of the PUCCH 602 having HARQ-ACK signaling.

The PUCCH 602 may be used to provide HARQ-ACK signaling from the UE to the base station that indicates whether the UE was able to receive and decode the information provided by the one or more scheduling PDSCHs 504. If the receipt and decoding of the scheduling information for the data PDSCH 506 from the one or more scheduling PDSCHs 504 by the UE was successful, the HARQ-ACK signaling in the PUCCH 602 may comprise an ACK. If the receipt and/or decoding of the scheduling information for the data PDSCH 506 from the one or more scheduling PDSCHs 504 by the UE was unsuccessful, the HARQ-ACK signaling in the PUCCH 602 may instead comprise a NACK. In the event of a NACK (or in the event that any expected PUCCH 602 does not arrive at the base station at all), the base station may determine that the UE may not in any event use the data PDSCH 506 and may accordingly cancel its transmission of the data PDSCH 506 in order to save network resources.

As illustrated in the diagram 600 of FIG. 6, either of the ultra compact DCI 502 and the one or more scheduling PDSCHs 504 (or any ones of these in any combination) provides the UE with sufficient information such that the UE is made aware of the time and frequency location(s) of the PUCCH 602 (e.g., the ultra compact DCI 502 and/or the some/all of the one or more scheduling PDSCHs 504 schedule the PUCCH 602).

Alternatively (or additionally), an SIB received at the UE may provide configuration information for the PUCCH 602, including (but not limited to) providing information regarding the time and/or frequency location of the PUCCH 602. In such circumstances, the configuration information for the PUCCH 602 in the SIB may relate the time and/or frequency position(s) of the PUCCH 602 relative to a received ultra compact DCI 502 and/or any of the one or more scheduling PDSCHs 504.

The diagram 600 of FIG. 6 illustrates the PUCCH 602 in between the one or more scheduling PDSCHs 504 and the data PDSCH 506. It is noted that in alternative embodiments, a PUCCH 602 as described herein might instead be positioned after the data PDSCH 506.

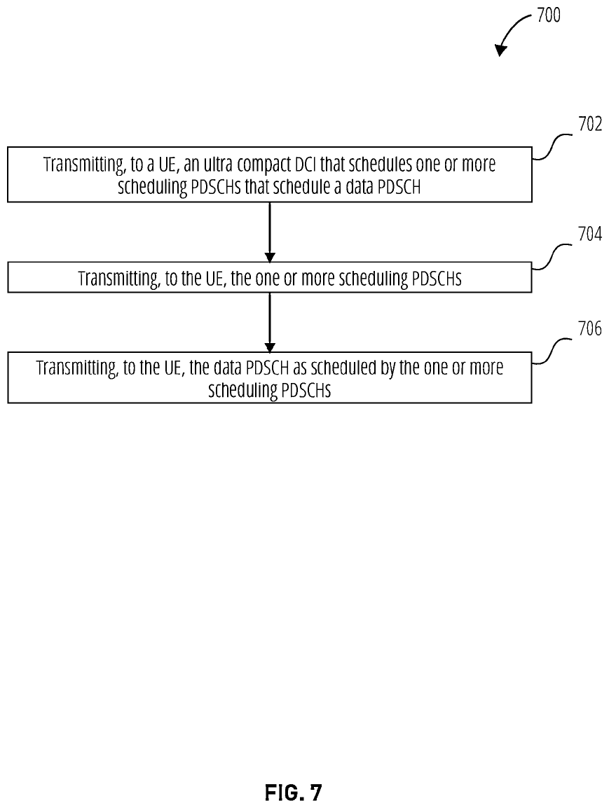

FIG. 7 illustrates a method 700 of a base station, according to an embodiment. The method 700 includes transmitting 702, to a UE, an ultra compact DCI that schedules one or more scheduling PDSCHs that schedule a data PDSCH.

The method 700 further includes transmitting 704, to the UE, the one or more scheduling PDSCHs.

The method 700 further includes transmitting 706, to the UE, the data PDSCH as scheduled by the one or more scheduling PDSCHs.

In some embodiments, the method 700 further includes receiving, from the UE, a PUCCH with HARQ-ACK signaling indicating that the UE decoded scheduling information from the one or more scheduling PDSCHs. In some of these embodiments, the ultra compact DCI schedules the PUCCH. In some of these embodiments, the one or more scheduling PDSCHs schedule the PUCCH.

In some embodiments, the method 700 further includes transmitting an SIB comprising configuration information for the ultra compact DCI.

In some embodiments, the method 700 further includes transmitting an SIB comprising configuration information for the one or more scheduling PDSCHs.

In some embodiments, the method 700 further includes transmitting an SIB comprising configuration information for a PUCCH for HARQ-ACK signaling corresponding to the one or more scheduling PDSCHs.

In some embodiments of the method 700, the one or more scheduling PDSCHs schedule the data PDSCH using a MAC CE.

In some embodiments of the method 700, the one or more scheduling PDSCHs comprise PDSCH repetitions.

In some embodiments, the method 700 further includes receiving, from the UE, HARQ-ACK signaling indicating that the UE received the data PDSCH.

Embodiments contemplated herein include an apparatus comprising means to perform one or more elements of the method 700. This apparatus may be, for example, an apparatus of a base station (such as a RAN device 1418 that is a base station, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a base station (such as a memory 1422 of a RAN device 1418 that is a base station, as described herein).

Embodiments contemplated herein include an apparatus comprising logic, modules, or circuitry to perform one or more elements of the method 700. This apparatus may be, for example, an apparatus of a base station (such as a RAN device 1418 that is a base station, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a base station (such as a RAN device 1418 that is a base station, as described herein).

Embodiments contemplated herein include a signal as described in or related to one or more elements of the method 700.

Embodiments contemplated herein include a computer program or computer program product comprising instructions, wherein execution of the program by a processing element is to cause the processing element to carry out one or more elements of the method 700. The processor may be a processor of a base station (such as a processor(s) 1420 of a RAN device 1418 that is a base station, as described herein). These instructions may be, for example, located in the processor and/or on a memory of the base station (such as a memory 1422 of a RAN device 1418 that is a base station, as described herein).

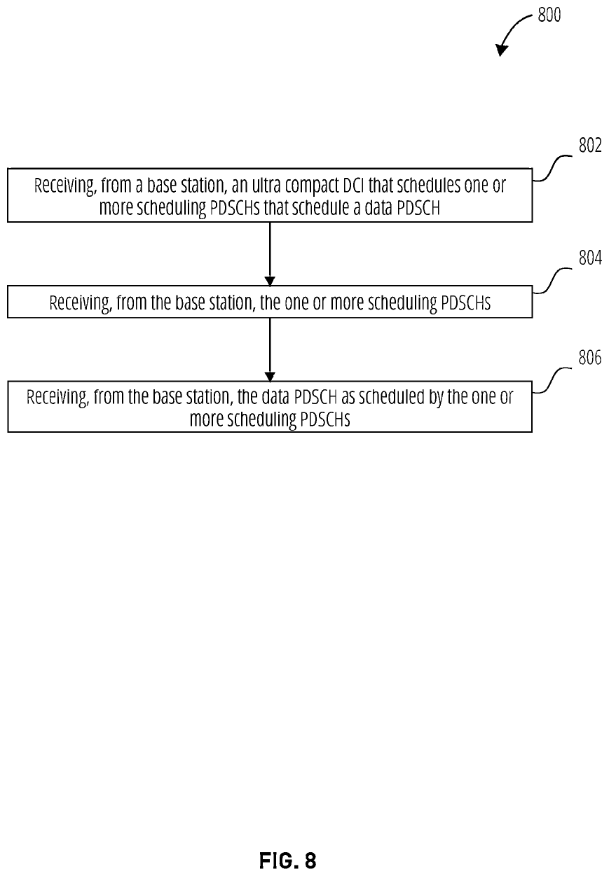

FIG. 8 illustrates a method 800 of a UE, according to an embodiment. The method 800 includes receiving 802, from a base station, an ultra compact DCI that schedules one or more scheduling PDSCHs that schedule a data PDSCH.

The method 800 further includes receiving 804, from the base station, the one or more scheduling PDSCHs.

The method 800 further includes receiving 806, from the base station, the data PDSCH as scheduled by the one or more scheduling PDSCHs.

In some embodiments, the method 800 further includes sending, to the base station, a PUCCH with HARQ-ACK signaling indicating that the UE decoded scheduling information from the one or more scheduling PDSCHs. In some of these embodiments, the ultra compact DCI schedules the PUCCH. In some of these embodiments, the one or more scheduling PDSCHs schedule the PUCCH.

In some embodiments, the method 800 further includes receiving an SIB comprising configuration information for the ultra compact DCI.

In some embodiments, the method 800 further includes receiving an SIB comprising configuration information for the one or more scheduling PDSCHs.

In some embodiments, the method 800 further includes receiving an SIB comprising configuration information for a PUCCH for HARQ-ACK signaling corresponding to the one or more scheduling PDSCHs.

In some embodiments of the method 800, the one or more scheduling PDSCHs schedule the data PDSCH using a MAC CE.

In some embodiments of the method 800, the one or more scheduling PDSCHs comprise PDSCH repetitions.

In some embodiments, the method 800 further comprises sending, to the base station, HARQ-ACK signaling indicating that the UE received the data PDSCH.

Embodiments contemplated herein include an apparatus comprising means to perform one or more elements of the method 800. This apparatus may be, for example, an apparatus of a UE (such as a wireless device 1402 that is a UE, as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a UE (such as a memory 1406 of a wireless device 1402 that is a UE, as described herein).

Embodiments contemplated herein include an apparatus comprising logic, modules, or circuitry to perform one or more elements of the method 800. This apparatus may be, for example, an apparatus of a UE (such as a wireless device 1402 that is a UE, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a UE (such as a wireless device 1402 that is a UE, as described herein).

Embodiments contemplated herein include a signal as described in or related to one or more elements of the method 800.

Embodiments contemplated herein include a computer program or computer program product comprising instructions, wherein execution of the program by a processor is to cause the processor to carry out one or more elements of the method 800. The processor may be a processor of a UE (such as a processor(s) 1404 of a wireless device 1402 that is a UE, as described herein). These instructions may be, for example, located in the processor and/or on a memory of the UE (such as a memory 1406 of a wireless device 1402 that is a UE, as described herein).

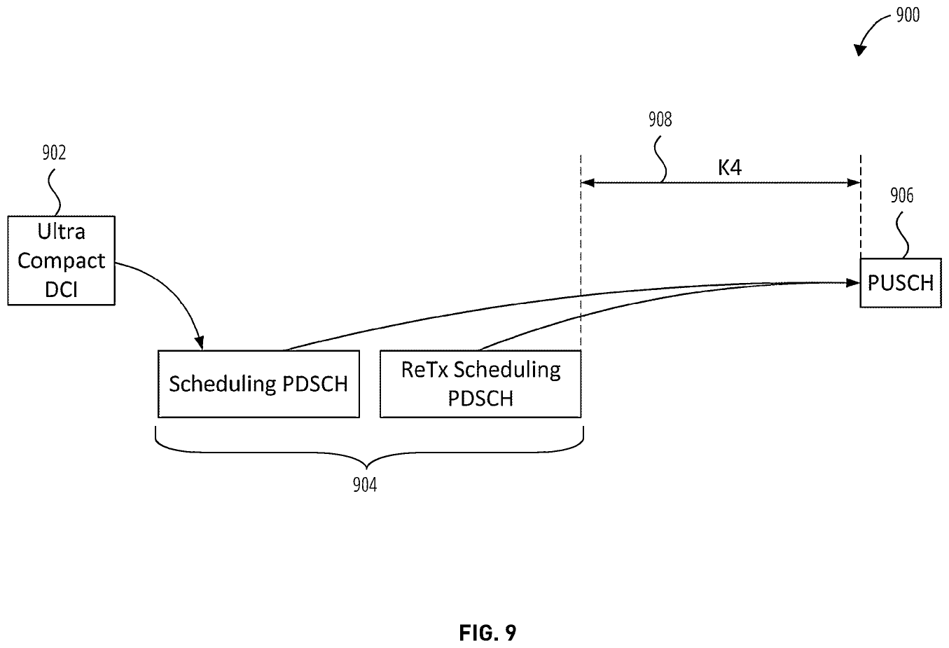

FIG. 9 illustrates a diagram 900 for a dynamic resource grant procedure for UL data transmission using ultra compact DCI and one or more scheduling PDSCHs, according to an embodiment. More specifically, the diagram 900 illustrates the use of an ultra compact DCI 902 and one or more scheduling PDSCHs 904 to schedule a PUSCH 906 for the UL data transmission.

The diagram 900 illustrates that the ultra compact DCI 902 is transmitted by the base station and received at the UE. The ultra compact DCI 902 provides the UE with sufficient information such that the UE is made aware of the time and frequency location(s) of the one or more scheduling PDSCHs 904 (e.g., the ultra compact DCI 902 schedules the one or more scheduling PDSCHs 904).

The one or more scheduling PDSCHs 904 are then transmitted by the base station as scheduled and received at the UE. The one or more scheduling PDSCHs 904 may include one or more medium access control control elements (MAC CEs) that include scheduling information for the PUSCH 906. The one or more scheduling PDSCHs 904 accordingly provide the UE (e.g., in the MAC CE(s)) with sufficient information such that the UE is made aware of the time and frequency location of the PUSCH 906 (e.g., the one or more scheduling PDSCHs 904 schedule the PUSCH 906).

In some embodiments, the one or more scheduling PDSCHs 904 comprises PDSCH repetitions. For example, in the case that the one or more scheduling PDSCHs 904 includes at least two PDSCHs, each of these two PDSCHs may be the same. In such cases, each of the one or more scheduling PDSCHs 904 would have, for example, a same MAC CE having scheduling information for the PUSCH 906. The use of such repetitions may provide the UE with additional reception opportunities for this data, thereby improving the probability that the UE will successfully receive and/or decode this data.

The PUSCH 906 is then transmitted by the UE as scheduled. The PUSCH 906 may include, for example, user plane (UP) data (e.g., application layer data for an application operating on the UE).

As illustrated, a minimum offset K4 908 between the last of the one or more scheduling PDSCHs 904 and the PUSCH 906 may be maintained by the network. In other words, the ultra compact DCI 902 may schedule the one or more scheduling PDSCHs 904, and the one or more scheduling PDSCHs 904 may schedule the PUSCH 906, such that a minimum offset K4 908 is maintained.

The base station may transmit a system information block (SIB) that includes configuration information for the ultra compact DCI 902 and/or for the one or more scheduling PDSCHs 904. The configuration information for the ultra compact DCI 902 as found in the SIB may be used by the UE to locate the ultra compact DCI 902.

Further, the configuration information for the one or more scheduling PDSCHs 904 as found in the SIB may further be used to locate the one or more scheduling PDSCHs 904 (in other words, the ultra compact DCI 902 may schedule the one or more scheduling PDSCHs 904 in light of/with the background assumption of any configuration for the one or more scheduling PDSCHs 904 provided in the SIB). In some cases, the configuration information for the one or more scheduling PDSCHs 904 in the SIB may relate the time and/or frequency position(s) of any of the one or more scheduling PDSCHs 904 relative to a received ultra compact DCI 902.

This SIB may be transmitted to the UE of the dynamic resource grant procedure of FIG. 9 by the base station of the dynamic resource grant procedure of FIG. 9 (e.g., that transmits the ultra compact DCI 902). Alternatively, the SIB may be transmitted to the UE of FIG. 9 by another base station.

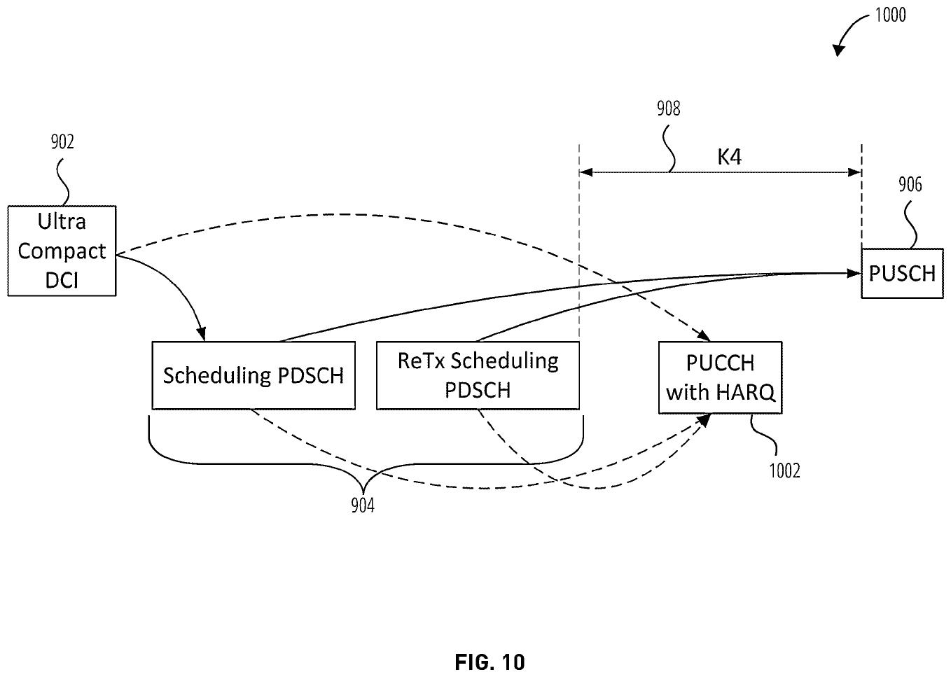

FIG. 10 illustrates a diagram 1000 for a dynamic resource grant procedure for UL data transmission using ultra compact DCI and one or more scheduling PDSCHs, according to an embodiment. The diagram 1000 is an expansion of the diagram 900 as described in relation to the diagram 900 of FIG. 9. Accordingly, the diagram 1000 illustrates the use of the ultra compact DCI 902, the one or more scheduling PDSCHs 904, the PUSCH 906, and the offset K4 908 as these were described in relation to the diagram 900 of FIG. 9. In addition to these elements from the diagram 900 of FIG. 9, the diagram 1000 of FIG. 10 additionally illustrates the scheduling and use of the PUCCH 1002 having HARQ-ACK signaling.

The PUCCH 1002 may be used to provide HARQ-ACK signaling from the UE to the base station that indicates whether the UE was able to receive and decode the information provided by the one or more scheduling PDSCHs 904. If the receipt and decoding of the scheduling information for the PUSCH 906 from the one or more scheduling PDSCHs 904 by the UE was successful, the HARQ-ACK signaling in the PUCCH 1002 may comprise an ACK. If the receipt and/or decoding of the scheduling information for the PUSCH 906 from the one or more scheduling PDSCHs 904 by the UE was unsuccessful, the HARQ-ACK signaling in the PUCCH 1002 may instead comprise a NACK. In the event of a NACK (or in the event that any expected PUCCH 1002 does not arrive at the base station at all), the base station may determine that the UE may not in any event use the PUSCH 906 and may accordingly cancel its scheduled reception attempt for the PUSCH 906 in order to save network resources.

As illustrated in the diagram 1000 of FIG. 10, either of the ultra compact DCI 902 and the one or more scheduling PDSCHs 904 (or any ones of these in any combination) provides the UE with sufficient information such that the UE is made aware of the time and frequency location(s) of the PUCCH 1002 (e.g., the ultra compact DCI 902 and/or the some/all of the one or more scheduling PDSCHs 904 schedule the PUCCH 1002).

Alternatively (or additionally), an SIB received at the UE may provide configuration information for the PUCCH 1002, including (but not limited to) providing information regarding the time and/or frequency location of the PUCCH 1002. In such circumstances, the configuration information for the PUCCH 1002 in the SIB may relate the time and/or frequency position(s) of the PUCCH 1002 relative to a received ultra compact DCI 902 and/or any of the one or more scheduling PDSCHs 904.

The diagram 1000 of FIG. 10 illustrates the PUCCH 1002 in between the one or more scheduling PDSCHs 904 and the PUSCH 906. It is noted that in alternative embodiments, a PUCCH 1002 as described herein might instead be positioned after the PUSCH 906.

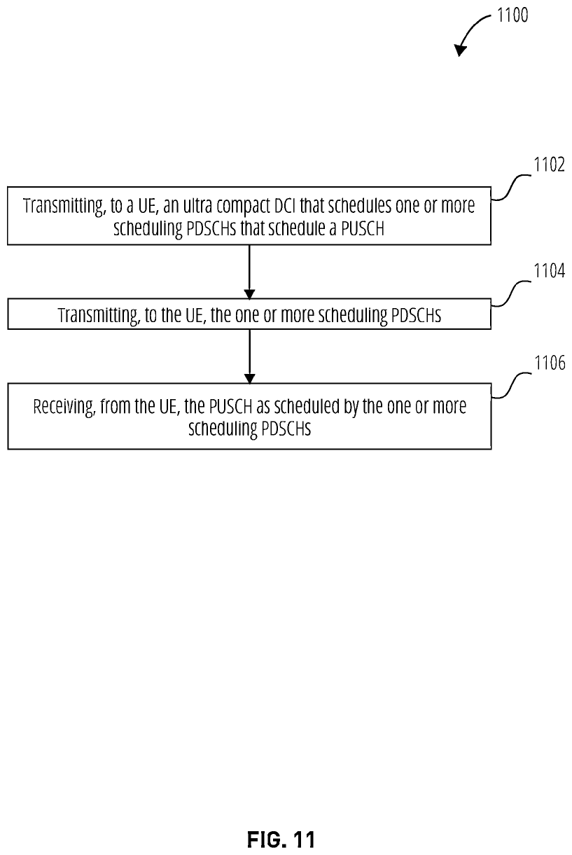

FIG. 11 illustrates a method 1100 of a base station, according to an embodiment. The method 1100 includes transmitting 1102, to a UE, an ultra compact DCI that schedules one or more scheduling PDSCHs that schedule a PUSCH.

The method 1100 further includes transmitting 1104, to the UE, the one or more scheduling PDSCHs.

The method 1100 further includes receiving 1106, from the UE, the PUSCH as scheduled by the one or more scheduling PDSCHs.

In some embodiments, the method 1100 further includes receiving, from the UE, a PUCCH with HARQ-ACK signaling indicating that the UE decoded scheduling information from the one or more scheduling PDSCHs. In some of these embodiments, the ultra compact DCI schedules the PUCCH. In some of these embodiments, the one or more scheduling PDSCHs schedule the PUCCH.

In some embodiments, the method 1100 further includes transmitting an SIB comprising configuration information for the ultra compact DCI.

In some embodiments, the method 1100 further includes transmitting an SIB comprising configuration information for the one or more scheduling PDSCHs.

In some embodiments, the method 1100 further includes transmitting an SIB comprising configuration information for a PUCCH for HARQ-ACK signaling corresponding to the one or more scheduling PDSCHs.

In some embodiments of the method 1100, the one or more scheduling PDSCHs schedule the PUSCH using a MAC CE.

In some embodiments of the method 1100, the one or more scheduling PDSCHs comprise PDSCH repetitions.

Embodiments contemplated herein include an apparatus comprising means to perform one or more elements of the method 1100. This apparatus may be, for example, an apparatus of a base station (such as a RAN device 1418 that is a base station, as described herein).

Embodiments contemplated herein include one or more non-transitory computer-readable media comprising instructions to cause an electronic device, upon execution of the instructions by one or more processors of the electronic device, to perform one or more elements of the method 1100. This non-transitory computer-readable media may be, for example, a memory of a base station (such as a memory 1422 of a RAN device 1418 that is a base station, as described herein).

Embodiments contemplated herein include an apparatus comprising logic, modules, or circuitry to perform one or more elements of the method 1100. This apparatus may be, for example, an apparatus of a base station (such as a RAN device 1418 that is a base station, as described herein).

Embodiments contemplated herein include an apparatus comprising: one or more processors and one or more computer-readable media comprising instructions that, when executed by the one or more processors, cause the one or more processors to perform one or more elements of the method 1100. This apparatus may be, for example, an apparatus of a base station (such as a RAN device 1418 that is a base station, as described herein).

Embodiments contemplated herein include a signal as described in or related to one or more elements of the method 1100.

Embodiments contemplated herein include a computer program or computer program product comprising instructions, wherein execution of the program by a processing element is to cause the processing element to carry out one or more elements of the method 1100. The processor may be a processor of a base station (such as a processor(s) 1420 of a RAN device 1418 that is a base station, as described herein). These instructions may be, for example, located in the processor and/or on a memory of the base station (such as a memory 1422 of a RAN device 1418 that is a base station, as described herein).

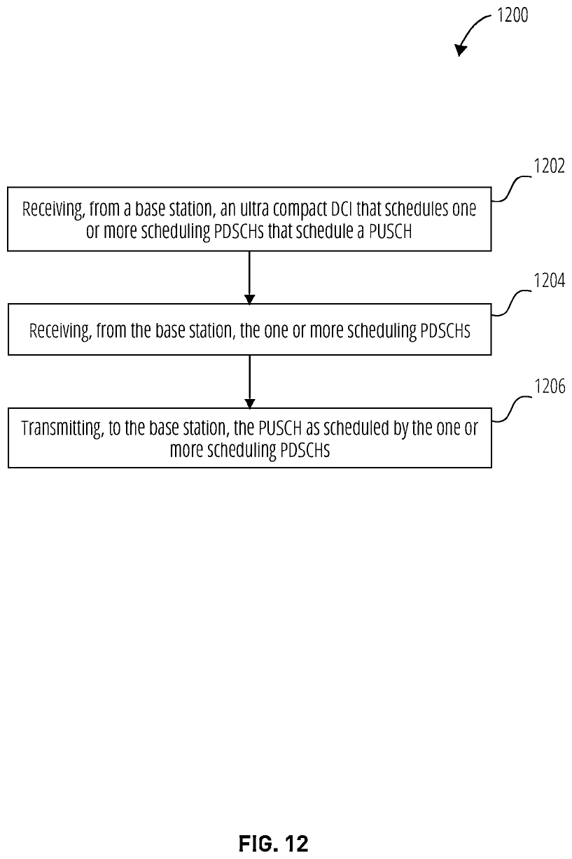

FIG. 12 illustrates a method 1200 of a UE, according to an embodiment. The method 1200 includes receiving 1202, from a base station, an ultra compact DCI that schedules one or more scheduling PDSCHs that schedule a PUSCH.

The method 1200 further includes receiving 1204, from the base station, the one or more scheduling PDSCHs.

The method 1200 further includes transmitting 1206, to the base station, the PUSCH as scheduled by the one or more scheduling PDSCHs.

In some embodiments, the method 1200 further includes sending, to the base station, a PUCCH with HARQ-ACK signaling indicating that the UE decoded scheduling information from the one or more scheduling PDSCHs. In some of these embodiments, the ultra compact DCI schedules the PUCCH. In some of these embodiments, the one or more scheduling PDSCHs schedule the PUCCH.

In some embodiments, the method 1200 further includes receiving an SIB comprising configuration information for the ultra compact DCI.

In some embodiments, the method 1200 further includes receiving an SIB comprising configuration information for the one or more scheduling PDSCHs.

In some embodiments, the method 1200 further includes receiving an SIB comprising configuration information for a PUCCH for HARQ-ACK signaling corresponding to the one or more scheduling PDSCHs.

In some embodiments of the method 1200, the one or more scheduling PDSCHs schedule the PUSCH using a MAC CE

In some embodiments of the method 1200, the one or more scheduling PDSCHs comprise PDSCH repetitions.

Embodiments contemplated herein include an apparatus comprising means to perform one or more elements of the method 1200. This apparatus may be, for example, an apparatus of a UE (such as a wireless device 1402 that is a UE, as described herein).

Embodiments contemplated herein include one or more non-transitory computer-readable media comprising instructions to cause an electronic device, upon execution of the instructions by one or more processors of the electronic device, to perform one or more elements of the method 1200. This non-transitory computer-readable media may be, for example, a memory of a UE (such as a memory 1406 of a wireless device 1402 that is a UE, as described herein).

Embodiments contemplated herein include an apparatus comprising logic, modules, or circuitry to perform one or more elements of the method 1200. This apparatus may be, for example, an apparatus of a UE (such as a wireless device 1402 that is a UE, as described herein).

Embodiments contemplated herein include an apparatus comprising: one or more processors and one or more computer-readable media comprising instructions that, when executed by the one or more processors, cause the one or more processors to perform one or more elements of the method 1200. This apparatus may be, for example, an apparatus of a UE (such as a wireless device 1402 that is a UE, as described herein).

Embodiments contemplated herein include a signal as described in or related to one or more elements of the method 1200.

Embodiments contemplated herein include a computer program or computer program product comprising instructions, wherein execution of the program by a processor is to cause the processor to carry out one or more elements of the method 1200. The processor may be a processor of a UE (such as a processor(s) 1404 of a wireless device 1402 that is a UE, as described herein). These instructions may be, for example, located in the processor and/or on a memory of the UE (such as a memory 1406 of a wireless device 1402 that is a UE, as described herein).

FIG. 13 illustrates an example architecture of a wireless communication system 1300, according to embodiments disclosed herein. The following description is provided for an example wireless communication system 1300 that operates in conjunction with the LTE system standards and/or 5G or NR system standards as provided by 3GPP technical specifications and other 3GPP documents.

As shown by FIG. 13, the wireless communication system 1300 includes UE 1302 and UE 1304 (although any number of UEs may be used). In this example, the UE 1302 and the UE 1304 are illustrated as smartphones (e.g., handheld touchscreen mobile computing devices connectable to one or more cellular networks), but may also comprise any mobile or non-mobile computing device configured for wireless communication.

The UE 1302 and UE 1304 may be configured to communicatively couple with a RAN 1306. In embodiments, the RAN 1306 may be NG-RAN, E-UTRAN, etc. The UE 1302 and UE 1304 utilize connections (or channels) (shown as connection 1308 and connection 1310, respectively) with the RAN 1306, each of which comprises a physical communications interface. The RAN 1306 can include one or more base stations (such as terrestrial base station 1312, the terrestrial base station 1314, the satellite base station 1336 and the satellite base station 1338) and/or other entities (e.g., the satellite 1342, which may not have base station functionality) that enable the connection 1308 and connection 1310. One or more satellite gateways 1334 may integrate the satellite base station 1336, satellite base station 1338, and/or the satellite 1342 into the RAN 1306, in the manners (and with the appropriate elements) described in relation to the NTN architecture 100 of FIG. 1 and the NTN architecture 200 of FIG. 2.

In this example, the connection 1308 and connection 1310 are air interfaces to enable such communicative coupling, and may be consistent with RAT(s) used by the RAN 1306, such as, for example, an LTE and/or NR. It is contemplated that the connection 1308 and connection 1310 may include, in some embodiments, service links between their respective UE 1302, UE 1304 and one or more of the satellite base station 1336, the satellite base station 1338, and the satellite 1342.

In some embodiments, the UE 1302 and UE 1304 may also directly exchange communication data via a sidelink interface 1316.

The UE 1304 is shown to be configured to access an access point (shown as AP 1318) via connection 1320. By way of example, the connection 1320 can comprise a local wireless connection, such as a connection consistent with any IEEE 802.11 protocol, wherein the AP 1318 may comprise a Wi-Fi® router. In this example, the AP 1318 may be connected to another network (for example, the Internet) without going through a CN 1324.

In embodiments, the UE 1302 and UE 1304 can be configured to communicate using orthogonal frequency division multiplexing (OFDM) communication signals with each other, with the terrestrial base station 1312, the terrestrial base station 1314, the satellite base station 1336, the satellite base station 1338, and/or the satellite 1342 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the terrestrial base station 1312, terrestrial base station 1314, the satellite base station 1336 and/or the satellite base station 1338 may be implemented as one or more software entities running on server computers as part of a virtual network.

In addition, or in other embodiments, the terrestrial base station 1312 or terrestrial base station 1314 may be configured to communicate with one another via interface 1322. In embodiments where the wireless communication system 1300 is an LTE system (e.g., when the CN 1324 is an EPC), the interface 1322 may be an X2 interface. The X2 interface may be defined between two or more base stations (e.g., two or more eNBs and the like) that connect to an EPC, and/or between two eNBs connecting to the EPC. It is contemplated that an inter-satellite link (ISL) may carry the X2 interface between two satellite base stations.

In embodiments where the wireless communication system 1300 is an NR system (e.g., when CN 1324 is a 5GC), the interface 1322 may be an Xn interface. An Xn interface is defined between two or more base stations that connect to 5GC (e.g., CN 1324). For example, the Xn interface may be between two or more gNBs that connect to 5GC, a gNB connecting to 5GC and an eNB, between two eNBs connecting to 5GC, and/or two or more satellite base stations via an ISL (as in, e.g., the interface 1340 between the satellite base station 1336 and the satellite base station 1338).

The RAN 1306 is shown to be communicatively coupled to the CN 1324. The CN 1324 may comprise one or more network elements 1326, which are configured to offer various data and telecommunications services to customers/subscribers (e.g., users of UE 1302 and UE 1304) who are connected to the CN 1324 via the RAN 1306. The components of the CN 1324 may be implemented in one physical device or separate physical devices including components to read and execute instructions from a machine-readable or computer-readable medium (e.g., a non-transitory machine-readable storage medium). For example, the components of the CN 1324 may be implemented in one or more processors and/or one or more associated memories.

In embodiments, the CN 1324 may be an EPC, and the RAN 1306 may be connected with the CN 1324 via an S1 interface 1328. In embodiments, the S1 interface 1328 may be split into two parts, an S1 user plane (S1-U) interface, which carries traffic data between the terrestrial base station 1312, terrestrial base station 1314, the satellite base station 1336, or the interface 1340 and a serving gateway (S-GW), and the S1-MME interface, which is a signaling interface between the terrestrial base station 1312, the terrestrial base station 1314, the satellite base station 1336, or the interface 1340 and mobility management entities (MMEs).

In embodiments, the CN 1324 may be a 5GC, and the RAN 1306 may be connected with the CN 1324 via an NG interface 1328. In embodiments, the NG interface 1328 may be split into two parts, an NG user plane (NG-U) interface, which carries traffic data between the terrestrial base station 1312, terrestrial base station 1314, satellite base station 1336, or satellite base station 1338 and a user plane function (UPF), and the S1 control plane (NG-C) interface, which is a signaling interface between the terrestrial base station 1312, terrestrial base station 1314, satellite base station 1336, or satellite base station 1338 and access and mobility management functions (AMFs).

Generally, an application server 1330 may be an element offering applications that use internet protocol (IP) bearer resources with the CN 1324 (e.g., packet switched data services). The application server 1330 can also be configured to support one or more communication services (e.g., VOIP sessions, group communication sessions, etc.) for the UE 1302 and UE 1304 via the CN 1324. The application server 1330 may communicate with the CN 1324 through an IP communications interface 1332.

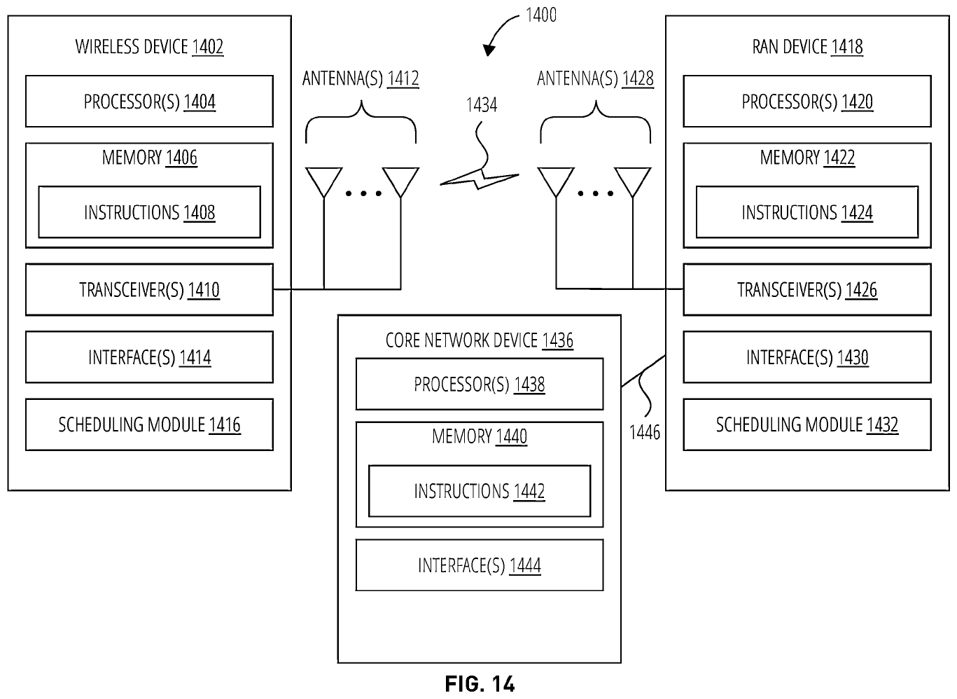

FIG. 14 illustrates a system 1400 for performing signaling 1434 between a wireless device 1402 and a RAN device 1418 connected to a core network of a CN device 1436, according to embodiments disclosed herein. The system 1400 may be a portion of a wireless communications system as herein described. The wireless device 1402 may be, for example, a UE of a wireless communication system. The RAN device 1418 may be, for example, a base station (e.g., an eNB or a gNB) of a wireless communication system that is a terrestrial base station or a satellite base station. In the case of a RAN device 1418 that is a terrestrial base station, the RAN device 1418 may be in communication with a satellite that directly provides radio access connectivity to a UE, in the manner described herein. The CN device 1436 may be one or more devices making up a CN, as described herein.

The wireless device 1402 may include one or more processor(s) 1404. The processor(s) 1404 may execute instructions such that various operations of the wireless device 1402 are performed, as described herein. The processor(s) 1404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1402 may include a memory 1406. The memory 1406 may be a non-transitory computer-readable storage medium that stores instructions 1408 (which may include, for example, the instructions being executed by the processor(s) 1404). The instructions 1408 may also be referred to as program code or a computer program. The memory 1406 may also store data used by, and results computed by, the processor(s) 1404.

The wireless device 1402 may include one or more transceiver(s) 1410 that may include radio frequency (RF) transmitter and/or receiver circuitry that use the antenna(s) 1412 of the wireless device 1402 to facilitate signaling (e.g., the signaling 1434) to and/or from the wireless device 1402 with other devices (e.g., the RAN device 1418) according to corresponding RATs. In some embodiments, the antenna(s) 1412 may include a moving parabolic antenna, an omni-directional phased-array antenna, or some other antenna suitable for communication with a satellite, (e.g., as described above in relation to the UE 110 of FIG. 1 and the UE 208 of FIG. 2).

For a RAN device 1418 that is a terrestrial base station, the network device signaling 1434 may occur on a feeder link between the wireless device 1402 and a satellite, and on a service link between the satellite and the RAN device 1418 (e.g., as described in relation to FIG. 1). For a RAN device 1418 that is a satellite base station, the signaling 1434 may occur on a feeder link between the wireless device 1402 and the RAN device 1418 (e.g., as described in relation to FIG. 2).

The wireless device 1402 may include one or more antenna(s) 1412 (e.g., one, two, four, or more). For embodiments with multiple antenna(s) 1412, the wireless device 1402 may leverage the spatial diversity of such multiple antenna(s) 1412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1402 may be accomplished according to precoding (or digital beamforming) that is applied at the wireless device 1402 that multiplexes the data streams across the antenna(s) 1412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1402 may implement analog beamforming techniques, whereby phases of the signals sent by the antenna(s) 1412 are relatively adjusted such that the (joint) transmission of the antenna(s) 1412 can be directed (this is sometimes referred to as beam steering).

The wireless device 1402 may include one or more interface(s) 1414. The interface(s) 1414 may be used to provide input to or output from the wireless device 1402. For example, a wireless device 1402 that is a UE may include interface(s) 1414 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1410/antenna(s) 1412 already described) that allow for communication between the UE and other devices and may operate according to known protocols (e.g., Wi-Fi®, Bluetooth®, and the like).

The wireless device 1402 may include a scheduling module 1416. The scheduling module 1416 may be implemented via hardware, software, or combinations thereof. For example, the scheduling module 1416 may be implemented as a processor, circuit, and/or instructions 1408 stored in the memory 1406 and executed by the processor(s) 1404. In some examples, the scheduling module 1416 may be integrated within the processor(s) 1404 and/or the transceiver(s) 1410. For example, the scheduling module 1416 may be implemented by a combination of software components (e.g., executed by a DSP or a general processor) and hardware components (e.g., logic gates and circuitry) within the processor(s) 1404 or the transceiver(s) 1410.

The scheduling module 1416 may be used for various aspects of the present disclosure, for example, aspects of FIG. 3 through FIG. 12. The scheduling module 1416 is configured to, for example, process ultra compact DCI and/or scheduling PDSCHs received at the wireless device 1402.

The RAN device 1418 may include one or more processor(s) 1420. The processor(s) 1420 may execute instructions such that various operations of the RAN device 1418 are performed, as described herein. The processor(s) 1404 may include one or more baseband processors implemented using, for example, a CPU, a DSP, an ASIC, a controller, an FPGA device, another hardware device, a firmware device, or any combination thereof configured to perform the operations described herein.

The RAN device 1418 may include a memory 1422. The memory 1422 may be a non-transitory computer-readable storage medium that stores instructions 1424 (which may include, for example, the instructions being executed by the processor(s) 1420). The instructions 1424 may also be referred to as program code or a computer program. The memory 1422 may also store data used by, and results computed by, the processor(s) 1420.

The RAN device 1418 may include one or more transceiver(s) 1426 that may include RF transmitter and/or receiver circuitry that use the antenna(s) 1428 of the RAN device 1418 to facilitate signaling (e.g., the signaling 1434) to and/or from the RAN device 1418 with other devices (e.g., the wireless device 1402) according to corresponding RATs.

The RAN device 1418 may include one or more antenna(s) 1428 (e.g., one, two, four, or more). In embodiments having multiple antenna(s) 1428, the RAN device 1418 may perform MIMO, digital beamforming, analog beamforming, beam steering, etc., as has been described.

For a RAN device 1418 that is a terrestrial base station, one or more of the transceiver(s) 1426 and/or the antenna(s) 1428 may instead be present on a satellite gateway associated with the base station (e.g., as shown in reference to the terrestrial base station 104 and the satellite gateway 106 of FIG. 1). For a RAN device 1418 that is a satellite base station, the transceiver(s) 1426 and/or the antenna(s) 1428 may be present on the satellite, and one or more of those antenna(s) 1428 may be antenna(s) appropriate for satellite communication (such as a moving parabolic antenna, an omni-directional phased-array antenna, etc.)

The RAN device 1418 may include one or more interface(s) 1430. The interface(s) 1430 may be used to provide input to or output from the RAN device 1418. For example, a RAN device 1418 that is a base station may include interface(s) 1430 made up of transmitters, receivers, and other circuitry (e.g., other than the transceiver(s) 1426/antenna(s) 1428 already described) that enables the base station to communicate with other equipment in a CN, and/or that enables the base station to communicate with external networks, computers, databases, and the like for purposes of operations, administration, and maintenance of the base station or other equipment operably connected thereto.

The RAN device 1418 may include a scheduling module 1432. The scheduling module 1432 may be implemented via hardware, software, or combinations thereof. For example, the scheduling module 1432 may be implemented as a processor, circuit, and/or instructions 1424 stored in the memory 1422 and executed by the processor(s) 1420. In some examples, the scheduling module 1432 may be integrated within the processor(s) 1420 and/or the transceiver(s) 1426. For example, the scheduling module 1432 may be implemented by a combination of software components (e.g., executed by a DSP or a general processor) and hardware components (e.g., logic gates and circuitry) within the processor(s) 1420 or the transceiver(s) 1426.

The scheduling module 1432 may be used for various aspects of the present disclosure, for example, aspects of FIG. 3 through FIG. 12. The scheduling module 1432 is configured to, for example, generate and/or transmit ultra compact DCI and/or scheduling PDSCHs sent by the RAN device 1418.

The RAN device 1418 may communicate with the CN device 1436 via the interface 1446, which may be analogous to the interface 1328 of FIG. 13 (e.g., may be an S1 and/or NG interface, either of which may be split into user plane and control plane parts).

The CN device 1436 may include one or more processor(s) 1438. The processor(s) 1438 may execute instructions such that various operations of the CN device 1436 are performed, as described herein. The processor(s) 1438 may include one or more baseband processors implemented using, for example, a CPU, a DSP, an ASIC, a controller, an FPGA device, another hardware device, a firmware device, or any combination thereof configured to perform the operations described herein.

The CN device 1436 may include a memory 1440. The memory 1440 may be a non-transitory computer-readable storage medium that stores instructions 1442 (which may include, for example, the instructions being executed by the processor(s) 1438). The instructions 1442 may also be referred to as program code or a computer program. The memory 1440 may also store data used by, and results computed by, the processor(s) 1438.

The CN device 1436 may include one or more interface(s) 1444. The interface(s) 1444 may be used to provide input to or output from the CN device 1436. For example, a CN device 1436 may include interface(s) 1430 made up of transmitters, receivers, and other circuitry that enables the CN device 1436 to communicate with other equipment in the CN, and/or that enables the CN device 1436 to communicate with external networks, computers, databases, and the like for purposes of operations, administration, and maintenance of the CN device 1436 or other equipment operably connected thereto.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a base station, comprising:
transmitting, to a user equipment (UE), an ultra compact downlink control information (DCI) that schedules one or more scheduling physical downlink shared channels (PDSCHs) that schedule a data PDSCH;
transmitting, to the UE, the one or more scheduling PDSCHs; and
transmitting, to the UE, the data PDSCH as scheduled by the one or more scheduling PDSCHs.

2. The method of claim 1, further comprising receiving, from the UE, a physical uplink control channel (PUCCH) with hybrid automatic repeat request acknowledgement (HARQ-ACK) signaling indicating that the UE decoded scheduling information from the one or more scheduling PDSCHs.

3. The method of claim 2, wherein the ultra compact DCI schedules the PUCCH.

4. The method of claim 2, wherein the one or more scheduling PDSCHs schedule the PUCCH.

5. The method of claim 1, further comprising transmitting a system information block (SIB) comprising configuration information for the ultra compact DCI.

6. The method of claim 1, further comprising transmitting a system information block (SIB) comprising configuration information for the one or more scheduling PDSCHs.

7. The method of claim 1, further comprising transmitting a system information block (SIB) comprising configuration information for a physical uplink control channel (PUCCH) for hybrid automatic repeat request acknowledgement (HARQ-ACK) signaling corresponding to the one or more scheduling PDSCHs.

8. The method of claim 1, wherein the one or more scheduling PDSCHs schedule the data PDSCH using a medium access control control element (MAC CE).

9. The method of claim 1, wherein the one or more scheduling PDSCHs comprise PDSCH repetitions.

10. The method of claim 1, further comprising receiving, from the UE, hybrid automatic repeat request acknowledgement (HARQ-ACK) signaling indicating that the UE received the data PDSCH.

11. A method of a user equipment (UE), comprising:
receiving, from a base station, an ultra compact downlink control information (DCI) that schedules one or more scheduling physical downlink shared channels (PDSCHs) that schedule a data PDSCH;
receiving, from the base station, the one or more scheduling PDSCHs; and
receiving, from the base station, the data PDSCH as scheduled by the one or more scheduling PDSCHs.

12. The method of claim 11, further comprising sending, to the base station, a physical uplink control channel (PUCCH) with hybrid automatic repeat request acknowledgement (HARQ-ACK) signaling indicating that the UE decoded scheduling information from the one or more scheduling PDSCHs.

13. The method of claim 12, wherein the ultra compact DCI schedules the PUCCH.

14. The method of claim 12, wherein the one or more scheduling PDSCHs schedule the PUCCH.

15. The method of claim 11, further comprising receiving a system information block (SIB) comprising configuration information for the ultra compact DCI.

16. The method of claim 11, further comprising receiving a system information block (SIB) comprising configuration information for the one or more scheduling PDSCHs.

17. The method of claim 11, further comprising receiving a system information block (SIB) comprising configuration information for a physical uplink control channel (PUCCH) for hybrid automatic repeat request acknowledgement (HARQ-ACK) signaling corresponding to the one or more scheduling PDSCHs.

18. The method of claim 11, wherein the one or more scheduling PDSCHs schedule the data PDSCH using a medium access control control element (MAC CE).

19. The method of claim 11, wherein the one or more scheduling PDSCHs comprise PDSCH repetitions.

20. The method of claim 11, further comprising sending, to the base station, hybrid automatic repeat request acknowledgement (HARQ-ACK) signaling indicating that the UE received the data PDSCH.

21-41. (canceled)
